(19) United States
(12) Patent Application Publication
(10) Pub. No.: US 2004/0190062 A1
(43) Pub. Date: Sep. 30, 2004

(54) Image duplication system and method

(76) Inventor: C. Kevin McIntyre, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/397,156

(22) Filed: Mar. 26, 2003

(51) Int. Cl. G06F 15/00

(52) U.S. Cl. 358/1.18; 358/1.2

(57) ABSTRACT

In one embodiment, a system and method are provided for formatting source data to be imaged onto a print media. The system is configured to format a single page from the source data as multiple instances within a single page of print media. The formatted data can then be formed as a image by an imaging mechanism. In this manner, the system provides a user with additional formatting options and may reduce an amount of consumed print media.

### BACKGROUND

Imaging devices such as printers and associated software have allowed users to format data with a variety of options. For example, using an N-up command at a driver level executed by a host device for certain Hewlett-Packard printers, a user can request that N pages of a document be printed on a single sheet of paper. On other manufacturers' printers, this option may be referenced by a different name. Thus, a twenty (20) page document can be printed on five (5) sheets of paper by printing four (N=4) pages per sheet. In this manner, consumed paper can be reduced. However, printing the same page multiple times on a single output page has not been provided. For example, in a copying operation, a user typically had to scan a page causing the page to be imaged on a sheet of paper, re-feed the paper, and re-scan the page with a different orientation so it would appear multiple times on the same sheet of paper.

The present invention provides a new and useful method and system of image duplication.

### BRIEF DESCRIPTION OF THE DRAWINGS

In the accompanying drawings which are incorporated in and constitute a part of the specification, embodiments of a system and method are illustrated, which together with the detailed description given below, serve to describe the example embodiments of the system and method. It will be appreciated that the illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vise versa.

FIG. 1 is one embodiment a duplication logic embodied within a host device.

FIG. 2 is one embodiment of an imaged print media having multiple instances of a single page.

FIG. 3 is one embodiment a methodology for formatting print data.

FIG. 4 is one embodiment a data formatting logic embodied within an image forming device.

FIG. 5 is another embodiment a methodology for formatting print data.

### DETAILED DESCRIPTION OF ILLUSTRATED EMBODIMENTS

The following includes definitions of selected terms used throughout the disclosure. The definitions include examples of various embodiments and/or forms of components that fall within the scope of a term and that may be used for implementation. Of course, the examples are not intended to be limiting and other embodiments may be implemented. Both singular and plural forms of all terms fall within each meaning:

“Computer-readable medium” as used herein refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Transmission media may include coaxial cables, copper wire, and fiber optic cables. Transmission media can also take the form of acoustic or light waves, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or cartridge, a carrier wave/pulse, or any other medium from which a computer, processor or other electronic device can read. Signals used to propagate instructions or other software over a network, such as the Internet, are also considered a “computer-readable medium.”

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), a programmable/programmed logic device, memory device containing instructions, or the like. Logic may also be fully embodied as software.

“Signal”, as used herein, includes but is not limited to one or more electrical signals, analog or digital signals, one or more computer or processor instructions, messages, a bit or bit stream, or other means that can be received, transmitted, and/or detected.

“Software”, as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“User”, as used herein, includes but is not limited to one or more persons, software, computers or other devices, or combinations of these.

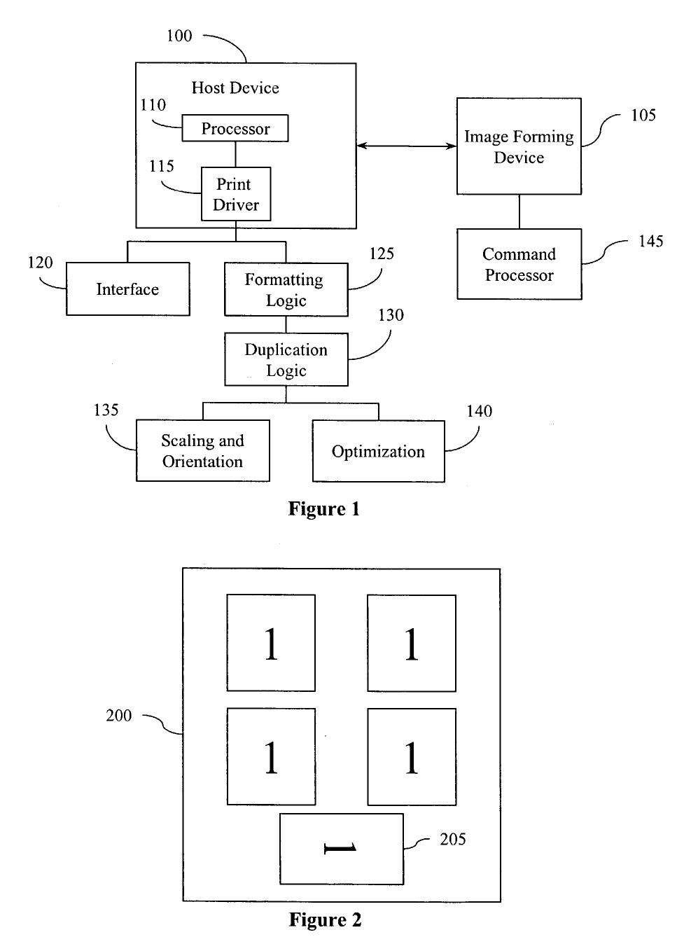

Illustrated in FIG. 1 is one embodiment of a host-based imaging system where one or more host devices 100 provide data, instructions, or both to an image forming device 105. The host device 100 can be a computer, a server, a portable processing device, a digital camera, a cellular telephone, or other device that can communicate data to an image forming device. Data can have any type of signal form or format including digital, analog, video, and others. The image forming device 105 can be a printer, copier, an all-in-one product, a multifunctional peripheral, or other device that can form an image onto print media. The image forming device 105 can include various types of imaging mechanisms based on, for example, ink jet technology, laser printing technology, digital imaging, or other available technologies.

In the following embodiment, the system will be described with an example configuration having a computer as the host device 100 that communicates imaging requests to a printer. The host device 100 includes a processor 110 that processes data and instructions between the components of the computer system which may include memory, storage, an operating system, network communications, and other components as is known.

In one embodiment, the host device 100 includes a print driver 115 configured to communicate with the image forming device 105. The print driver 115 may be embodied as software installed on the host device 100 that is executed when a print request is desired. During a print request, an interface 120 can be displayed to allow a user to select various print options. The interface 120 may be, for example, a dialog window or other type of input mechanism that can be displayed through a software application when a user wishes to print a document or other type of printable data. The interface 120 may also be a control panel with selectable options. A control panel may also be on the image forming device 105.

Once the print options have been selected, a formatting logic 125 formats the source data in accordance with selectable print options and data format requirements of the particular printer. Formatting may include a wide variety of user selectable options including formatting the print resolution, margins, color or grayscale values, duplication options and other options. The formatting logic 125 is configured to generate rendered image data that are printer ready bits. In another embodiment, the formatting logic 125 may be configured to generate imaging instructions that instruct an image forming device to render the image data at its end if such processing is available on the image forming device.

In one embodiment, a selectable print option allows a single page to be duplicated N times on a signal output page. In this regard, a duplication logic 130 is configured to format the source data such that multiple instances or copies of a single page from the source data is imaged on a single page of a print media. The duplication logic 130 may be initiated based on a selected option from the interface 120. For example, the option allows a user to identify one page from the source data and identify a number of times the one page is to be duplicated onto a single page of the print media. The duplication logic 130 may also be configured to allow multiple pages to be duplicated multiple times on a single output page if desired. Another configuration includes imaging on duplex pages.

A scaling and orientation logic 135 may be configured to determine how the multiple instances of the source page will fit within the physical dimensions of a single page of the print media. This may include having logic that determines the dimensions of the source page and the physical dimensions of the output page. Of course, one or both of these dimensions may be received from another component of the host device and/or the image forming device, or received from a print setting that identifies the size of the page. Knowing the dimensions, the source page can be scaled to a size such that the selected number of instances/copies will fit within the dimensions of the output page of the print media. The orientation logic can then calculate positions within the output page where each instance of the scaled source page will be positioned.

It will be appreciated that there are numerous formatting options for positioning the multiple instances relative to each other. For example, they may be equally spaced from one another, directly adjacent to each other, overlapping each other, rotated in one or more angles, or positioned in other desired ways. Options may also be provided to allow a user to designate a selected type of scaling such as a selected percentage scaled from the original size, or other types of scaling options. The logic may allow selected scaling sizes and/or orientations that do not necessarily fit on the output page.

In one embodiment, an optimization logic 140 may be included that is configured to optimize the size, orientation, and/or positioning of each instance of the source page. For example, the scaling and orientation of the multiple instances may be determined based on a desire to obtain a maximum size of each instance. Another optimization may be based on a desire to image the multiple instances such that the least amount of non-imaged space remains on the output page. It will be appreciated that the size and orientation of each instance of the source page may be different from one another. For example, FIG. 2 illustrates one embodiment of an output page 200 of print media imaged with five instances of a page “1” from a source data. In this example, instance 205 is oriented differently than the other four instances and can be scaled to a different size. It will be appreciated that scaling includes both enlarging and reducing the size of a source page.

With reference again to FIG. 1, in one embodiment, the formatting logic 125 is configured to generate a rendered image of the source data that is print ready. The rendered image may then be transmitted to the image forming device 105 for imaging. The image forming device 105 may not include formatting logic of its own and would require the host device 100 to perform such formatting. The image forming device 105 may include a command processor 145 configured to recognize an instruction set and execute instructions received from the host device 100. In another embodiment, the formatting logic 125 can be configured to generate imaging instructions that indicate how the source data is to be formatted and imaged. The command processor 145 from the image forming device 105 would then format the source data based on the formatting instructions, duplication instructions, and other settings, and render print ready bits to be imaged onto a print media.

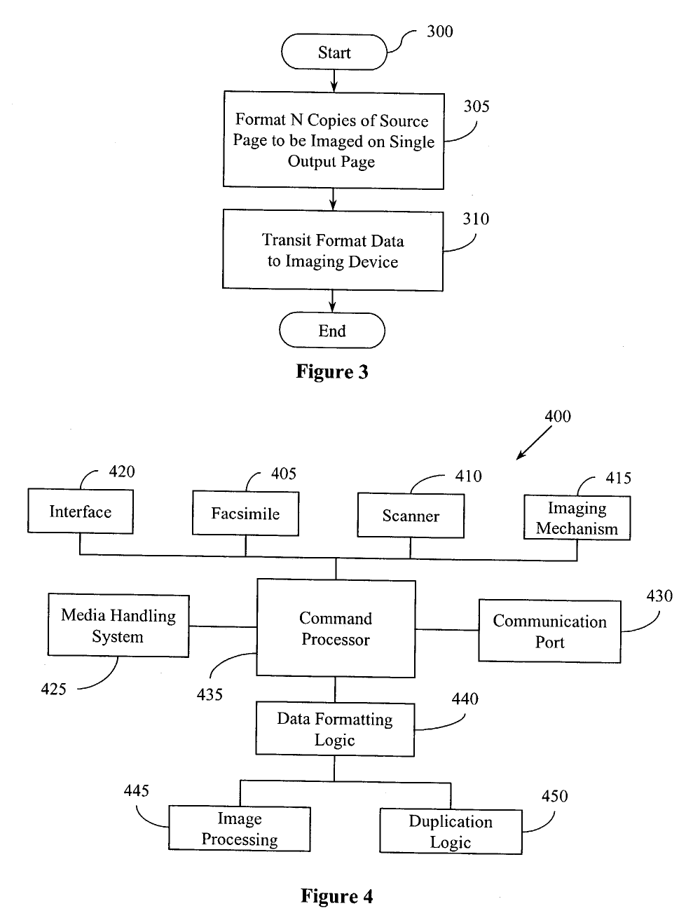

Illustrated in FIG. 3 is one embodiment of a methodology 300 for formatting image data such that a single page appears N times on an output page. The illustrated elements denote “processing blocks” and represent computer software instructions or groups of instructions that cause a computer or processor to perform an action(s) and/or to make decisions. Alternatively, the processing blocks may represent functions and/or actions performed by functionally equivalent circuits such as a digital signal processor circuit, an application specific integrated circuit (ASIC), or other logic device. The diagram, as well as the other illustrated diagrams, do not depict syntax of any particular programming language. Rather, the diagram illustrates functional information one skilled in the art could use to fabricate circuits, generate computer software, or use a combination of hardware and software to perform the illustrated processing. It will be appreciated that electronic and software applications may involve dynamic and flexible processes such that the illustrated blocks can be performed in other sequences different than the one shown and/or blocks may be combined or, separated into multiple components. They may also be implemented using various programming approaches such as machine language, procedural, object oriented and/or artificial intelligence techniques. The foregoing applies to all methodologies described herein.

With reference to FIG. 3, one embodiment of a methodology 300 for imaging a single page of source data multiple times on a single page of output print media is shown. If an option is selected for duplicating a single page multiple (N) times, the process formats N copies of the source page such that they will be imaged on a single output page (Block 305). The formatted data is then transmitted to an image forming device for imaging (Block 310). As mentioned previously, the format data may have a form of a rendered image ready for imaging or may be instructions for the image forming device to format and image the source data.

Although the previous examples describe a single page being duplicated, it will be appreciated that multiple pages from a document can each be duplicated multiple times on separate single pages of print media. For example, if a document includes pages 1-3, page 1 can be duplicated two or more times on a first output page, page 2 can be duplicated two or more times on a second output page, and page 3 can be duplicated two or more times on a third output page. Of course, pages can be imaged one time on an output page.

Illustrated in FIG. 4 is another embodiment of an image forming device 400 having multiple features. This device is generally known as an all-in-one product or a multifunctional peripheral (MFP). It will be appreciated that device 400, in other embodiments, may be a copier or other type of imaging device based on its configuration. The device 400 may include a facsimile 405, a scanner 410 and an imaging mechanism 415. With these components, the device 400 can perform the functions of faxing, scanning, copying, and printing. An interface 420 may be configured as a software controlled panel on the device 400 from which information can be displayed to a user and input instructions and options may be received from the user. One or more media handling mechanisms 425 control movement of print media through the device 400 along one or more paths. The paths direct the print media from an input position through the imaging mechanism 415 to a final output position. Rollers, belts, pulleys, pushers, and/or other types of components can be used to move the media. A communication port 430 with communication logic may be included such that the device 400 can electronically communicate with one or more other devices. A command processor 435 is configured to coordinate the components and control communication therebetween using, for example, operating system software. In one embodiment, the command processor 435 is a software controlled microprocessor or may be another type of logic device.

The imaging device 400 also includes a data formatting logic 440 configured to format the input data prior to imaging by the imaging mechanism 415. When formatted, print ready data will be generated from the input data that can be imaged. An image processing logic 445 may be configured to manipulate image characteristics of the input data such as lightness, darkness, background suppression, zooming, color or grayscale properties, or other types of characteristics. The image characteristics may be processed based on default settings, based on user inputted options, or both. A duplication logic 450 is configured to format the input data in accordance with an N-duplication option. The duplication logic 450 may be configured similar to the duplication logic 130 described in FIG. 1. With the N-duplication option, a user may designate through the interface 420 that a selected page from an input data is to be imaged N times on a single output page of the print media. Based on the number of copies of the selected page to be printed, the selected page is scaled and oriented in accordance with the physical dimensions of the output page. Of course, it is not required that the multiple copies actually fit on the output page. In this manner, the same page can be imaged multiple times on a single output page.

By way of an example, assume that a user wishes to copy a document. If the document is scanned by scanner 410, input data is generated representing each page of the scanned document. With the duplication logic 450, a selected page can be imaged multiple times on a single output page. The duplication logic 450 may also be configured to orient and image multiple different input pages onto a single output page. For example, pages 1-4 of a scanned document may be copied onto one page of print media.

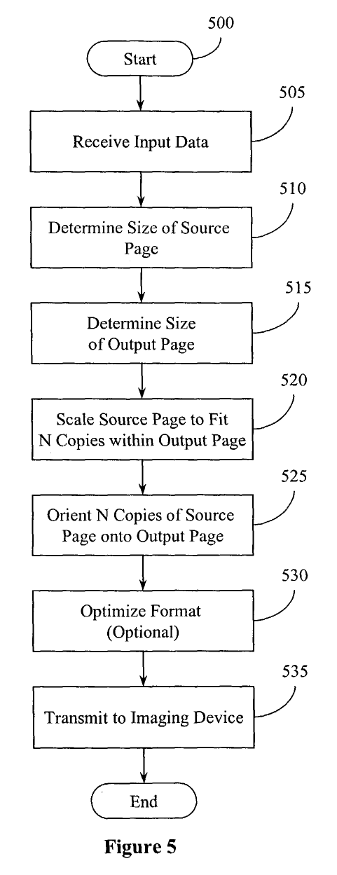

Illustrated in FIG. 5 is one embodiment of a methodology 500 that may be associated with the image forming device 400 of FIG. 4. Data to be imaged is first inputted/received (Block 505). The input data may be received from a host device, scanned in by a scanner, received from a facsimile transmission, or read from a computer-readable medium. At some point prior to imaging, an instruction is received that N copies of a selected page from the input data is to be imaged on a single output page. The data representing the selected page from the input data will be referred to as the source page for explanatory purposes. The size of the source page is then determined (Block 510). The size of the output page is also determined (Block 515). The source page is scaled to fit N copies or otherwise N instances of the source page within the dimensions of the output page (Block 520). The N copies of the scaled source page are then oriented such that they will be imaged within the dimensions of the output page (Block 525). Optionally, the orientation and scaling can be optimized to maximize the use of the output page, maximize the size of the source page for user readability, to minimize the amount of non-imaged space of the output page, or other desired optimization feature (Block 530). The formatted image data which now includes the N copies of the source page is transmitted to an image forming device to be rendered onto the output page (Block 535). The image forming device, based on the system configuration, may be a component within the system or may be a device in communication with the system.

Suitable software for implementing the various components of the present system and method using the teachings presented here include programming languages and tools such as Java, C#, C++, C, CGI, Perl, SQL, APIs, SDKs, assembly, firmware, microcode, and/or other languages and tools. The components embodied as software include computer-readable/executable instructions that cause one or more computers, processors and/or other electronic devices to behave in a prescribed manner. Any software, whether an entire system or a component of a system, may be embodied as an article of manufacture and maintained or communicated as part of a computer-readable medium as defined previously. Another form of the software may include signals that transmit program code of the software to a recipient over a network or other communication medium. It will be appreciated that components described herein and shown in the figures may be implemented as separate components or may be combined together.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

I claim:

1. An imaging system comprising:
duplication logic configured to format image data to be imaged such that multiple instances of one page from the image data are caused to be imaged on a single page of a print media; and
an image forming mechanism configured to image the source data onto the print media in accordance with the format from the duplication logic.

2. The system of claim 1 further including an interface configured to allow a user to select imaging options for imaging the image data including selecting a number of instances of the one page to be imaged on the single page.

3. The system of claim 1 further including a scanner configured to scan an original document and generate image data representing the original document.

4. The system of claim 1 wherein the duplication logic includes logic to determine dimensions of the one page from the image data and dimensions of the print media.

5. The system of claim 1 further including orientation logic configured to orient the multiple instances of the one page to fit within the single page of the print media.

6. The system of claim 5 wherein the orientation logic includes logic configured to change dimensions of one or more instances of the multiple instances.

7. The system of claim 1 wherein the duplication logic is embodied within a host device and the image forming mechanism is in electronic communication with the host device.

8. The system of claim 1 further including a facsimile device configured to electronically transmit the image data to a remote receiving device.

9. The system of claim 1 wherein the duplication logic is embodied within a print driver software.

10. An article of manufacture embodied in a computer-readable medium for formatting source data to be imaged, the article of manufacture comprising:
first processor executable instructions for causing a processor to format a single page from the source data as multiple instances within a single page of print media; and
second processor executable instructions for causing a processor to generate one or more imaging instructions for instructing an imaging mechanism to form the multiple instances of the single page of the source data onto the single page of the print media.

11. The article of manufacture as set forth in claim 10 further including third processor executable instructions for causing a processor to orient the multiple instances based on dimensions of the single page of the print media.

12. The article of manufacture as set forth in claim 11 wherein the third processor executable instructions further include instructions for causing a processor to optimize dimensions and orientations of each of the multiple instances based on the dimensions of the single page of the print media.

13. The article of manufacture as set forth in claim 10 wherein the second processor executable instructions are configured to generate the imaging instructions having a form of a print ready rendered image.

14. The article of manufacture as set forth in claim 10 wherein the second processor executable instructions are configured to generate the imaging instructions that instruct the imaging mechanism to format a rendered image of the multiple instances.

15. The article of manufacture as set forth in claim 10 further including fourth processor executable instructions for causing a processor to receive input signals indicating a number of instances of the single page to be imaged.

16. The article of manufacture as set forth in claim 10 further including fifth processor executable instructions for causing a processor to scale the single page of the source data.

17. A method of formatting print data to be imaged onto print media, the method comprising:
receiving an instruction to image a selected page from the print data N times onto a single page of the print media;
scaling the selected page to a scaled page such that N copies of the scaled page can be positioned on the single page of the print media; and
formatting an image data to be imaged on the single page of the print media, the image data having the N copies of the scaled page oriented therein.

18. The method as set forth in claim 17 further including determining a size of the selected page.

19. The method as set forth in claim 17 wherein the image data is formatted as print ready bits.

20. The method as set forth in claim 17 further including receiving the selected page by scanning.

21. An image forming device comprising:
a scanner for scanning one or more pages of a document and generating image data representing the one or more pages;
data formatting logic configured to format image data representing a selected page from the document such that multiple copies of the selected page appear within dimensions of a selected print media, and configured to generate rendered image data from the formatted image data; and
an imaging mechanism for forming an image on the selected print media in accordance with the rendered image data.

22. The image forming device as set forth in claim 21 further including duplication logic configured to scale the selected page based on the dimensions of the selected print media.

23. The image forming device as set forth in claim 21 wherein the image forming device is an all-in-one product.

24. The image forming device as set forth in claim 21 further including means for handling the print media through the image forming device.

25. The image forming device as set forth in claim 21 wherein the data formatting logic is configured to orient multiple different pages of the document to be imaged onto a single page of the print media.
